(19) United States
(12) Patent Application Publication
(10) Pub. No.: US 2026/0305697 A1
(43) Pub. Date: Oct. 8, 2026

(54) HEATER ASSEMBLY, AEROSOL-GENERATING APPARATUS COMPRISING SAME, AND METHOD FOR MANUFACTURING SAME HEATER ASSEMBLY

(71) Applicant: KT&G CORPORATION, Daejeon (KR)

(72) Inventors: In Su PARK, Daejeon (KR); Chan Min KWON, Daejeon (KR); Tae Kyun KIM, Daejeon (KR); Mi Jeong LEE, Daejeon (KR); John Tae LEE, Daejeon (KR); Tae Kyung LEE, Daejeon (KR)

(73) Assignee: KT&G CORPORATION, Daejeon (KR)

(21) Appl. No.: 18/880,638

(22) PCT Filed: Aug. 31, 2023
(86) PCT No.: PCT/KR2023/013035

§ 371 Date: Jan. 2, 2025

(30) Foreign Application Priority Data
Aug. 31, 2022 (KR) 10-2022-0110268
Aug. 30, 2023 (KR) 10-2023-0114764
Aug. 30, 2023 (KR) 10-2023-0114765

(51) Int. Cl. A24F 40/46; A24F 40/20; A24F 40/70

(52) U.S. Cl. CPC A24F 40/46; A24F 40/70; A24F 40/20

(57) ABSTRACT

A heater assembly for heating an aerosol generating article through a dielectric heating method includes an oscillating unit configured to generate microwaves, a resonating unit configured to generate an electric field by resonating the microwaves, and a coupler having one end in contact with the oscillating unit and another end in contact with the resonating unit and configured to transmit the microwaves generated by the oscillating unit to the resonating unit, wherein the oscillating unit includes a printed circuit board stacked on the resonating unit.

### TECHNICAL FIELD

Embodiments relate to a heater assembly capable of generating an aerosol by heating an aerosol generating article through a dielectric heating method, and an aerosol generating device including the heater assembly.

### BACKGROUND ART

Recently, the demand for alternative methods for overcoming the shortcomings of general cigarettes has increased. For example, there is an increasing demand for a system for generating aerosols by heating a cigarette(or ‘an aerosol generating article’) by using an aerosol generating device, rather than by burning cigarettes.

Recently, an aerosol generating device of a dielectric heating type that heats an aerosol generating article by using microwaves, rather than using a resistance heating type or an induction heating type, has been proposed. Microwave heating technology may cause a dielectric, which is included in an aerosol generating article, to generate heat according to resonance of microwaves, and heats the aerosol generating article by the heat generated in the dielectric.

In order to increase usability of the aerosol generating device of a dielectric heating type, it is necessary to appropriately arrange components of an oscillating unit and a resonating unit and to miniaturize the aerosol generating device while increasing heating efficiency.

### DISCLOSURE

### Technical Problem

Embodiments provide miniaturized heater assembly and aerosol generating device, which may heat an aerosol generating article through a dielectric heating method.

Embodiments may increase heating efficiency and a heat dissipation effect even in a miniaturized device by stacking an oscillating unit on a resonating unit.

The problems to be solved by embodiments are not limited to the problems described above, and problems not mentioned may be clearly understood by one of ordinary skill in the art to which the embodiments belong from the description and the accompanying drawings.

### Technical Solution

According to an aspect of the present disclosure, a heater assembly for heating an aerosol generating article through a dielectric heating method includes an oscillating unit configured to generate microwaves, a resonating unit configured to generate an electric field by resonating the microwaves, and a coupler having one end in contact with the oscillating unit and another end in contact with the resonating unit and configured to transmit the microwaves generated by the oscillating unit to the resonating unit, wherein the oscillating unit includes a printed circuit board stacked on the resonating unit.

According to another aspect of the present disclosure, an aerosol generating device includes a housing having an insertion hole into which an aerosol generating article is inserted, and a heater assembly for heating the aerosol generating article inserted through the insertion hole, wherein the heater assembly includes an oscillating unit including a printed circuit configured to generate microwaves, a resonating unit configured to generate an electric field by resonating the microwaves, and a coupler having one end in contact with the oscillating unit and another end in contact with the resonating unit and configured to transmit the microwaves generated by the oscillating unit to the resonating unit, and the oscillating unit is stacked on the resonating unit.

According to another aspect of the present disclosure, a method of manufacturing a heater assembly for heating an aerosol generating article includes providing a resonating unit, connecting a coupler to the resonating unit such that one end of the coupler is in contact with the resonating unit, and stacking an oscillating unit on the resonating unit, the oscillating unit including a printed circuit board stacked on the resonating unit and being in contact with another end of the coupler.

### Advantageous Effects

A heater assembly, an aerosol generating device, and a method of manufacturing the heater assembly according to embodiments may provide miniaturized heater assembly and aerosol generating device.

In addition, embodiments may provide a heater assembly, an aerosol generating device, and a method of manufacturing the heater assembly, which may increase heating efficiency and a heat dissipation effect even in a miniaturized device.

Effects of the present disclosure are not limited to the above effects, and effects that are not mentioned could be clearly understood by one of ordinary skill in the art from the present specification and the attached drawings.

### DESCRIPTION OF DRAWINGS

FIG. 1 is a perspective view of an aerosol generating device according to an embodiment.

FIG. 2 is an internal block diagram of an aerosol generating device according to an embodiment.

FIG. 3 is an internal block diagram of a dielectric heating unit of FIG. 2.

FIG. 4 is a perspective view of a heater assembly according to an embodiment.

FIG. 5 is a cross-sectional view of the heater assembly of FIG. 4.

FIG. 6 is a perspective view of a heater assembly according to another embodiment.

FIGS. 7A and 7B are cross-sectional views of heater assemblies according to some embodiments.

FIGS. 8A and 8B schematically illustrate a method of manufacturing the heater assembly of FIG. 7A.

FIGS. 9A to 9C schematically illustrate a method of manufacturing the heater assembly of FIG. 7B.

FIG. 10 is a perspective view of a heater assembly according to an embodiment.

### MODE FOR INVENTION

Hereinafter, embodiments disclosed in this specification will be described in detail with reference to the accompanying drawings, and identical or similar components will be assigned the same reference numbers, regardless of the drawing symbols, and redundant explanations will be omitted.

The suffixes “module” and “unit” used in this description are assigned or used interchangeably solely for the convenience of drafting the specification and do not themselves have distinct meanings or roles.

Also, in describing the embodiments disclosed in this specification, detailed descriptions of well-known technologies may be omitted if it is determined that they could obscure the essence of the embodiments disclosed herein. Additionally, the accompanying drawings are provided merely to facilitate the understanding of the embodiments disclosed in this specification, and the technical spirit disclosed herein is not limited by the drawings. It should be understood that all modifications, equivalents, and substitutes that fall within the spirit and scope of this disclosure are included.

Terms including ordinal numbers, such as first, second, etc., may be used to describe various components, but the components are not limited by the terms. The above terms are used solely to distinguish one component from another.

When a component is referred to as being “connected” or “coupled” to another component, it should be understood that the component may be directly connected or coupled to the other component, or there may be intervening components in between. On the other hand, when a component is referred to as being “directly connected” or “directly coupled” to another component, it should be understood that there are no intervening components in between.

Singular expressions include plural expressions unless the context clearly indicates otherwise.

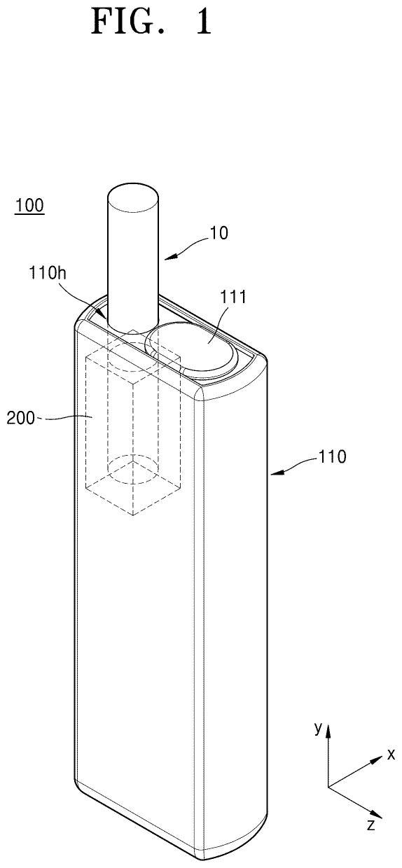

FIG. 1 is a perspective view of an aerosol generating device according to an embodiment.

Referring to FIG. 1, the aerosol generating device 100 according to an embodiment may include a housing 110 accommodating an aerosol generating article 10, and a heater assembly 200 configured to heat the aerosol generating article 10 accommodated in the housing 110.

The housing 110 may form an overall exterior of the aerosol generating device 100 and components of the aerosol generating device 100 may be arranged in an internal space (or a mounting space) of the housing 110. For example, the heater assembly 200, a battery, a processor, and/or a sensor may be arranged in the internal space of the housing 110, but the components arranged in the internal space are not limited thereto.

An insertion hole 110h may be formed in one region of the housing 110, and at least one region of the aerosol generating article 10 may be inserted into the housing 110 through the insertion hole 110h. For example, the insertion hole 110h may be formed in one region of a top surface (e.g., a surface facing a z direction) of the housing 110, but a location of the insertion hole 110h is not limited thereto. According to another embodiment, the insertion hole 110h may be formed in one region of a side surface (e.g., a surface facing an x direction) of the housing 110.

The heater assembly 200 is arranged in the internal space of the housing 110 and heat the aerosol generating article 10 inserted into or accommodated in the housing 110 through the insertion hole 110h. For example, the heater assembly 200 may heat the aerosol generating article 10 by being arranged to surround at least one region of the aerosol generating article 10 inserted into or accommodated in the housing 110.

According to an embodiment, the heater assembly 200 may heat the aerosol generating article 10 by using a dielectric heating method. In the disclosure, the dielectric heating method is a method of heating a dielectric that is an object to be heated, by using resonance of microwaves and/or an electric field (or including a magnetic field) of microwaves. Microwaves are an energy source for heating the object to be heated and are generated by high-frequency power, and thus, ‘microwaves’ may be interchangeably used with ‘microwave power.’

Charges or ions of the dielectric included in the aerosol generating article 10 may vibrate or rotate inside the heater assembly 200 by microwave resonance, and heat may be generated in the dielectric by frictional heat generated when the charges or ions vibrate or rotate, and thus, the aerosol generating article 10 may be heated.

When the aerosol generating article 10 is heated by the heater assembly 200, aerosols may be generated from the aerosol generating article 10. In the disclosure, aerosols may refer to gas particles generated when the air and vapor generated as the aerosol generating article 10 is heated are mixed with each other.

The aerosols generated from the aerosol generating article 10 may be discharged to the outside of the aerosol generating device 100 by passing through the aerosol generating article 10 or through an empty space between the aerosol generating article 10 and the insertion hole 110h. A user may smoke by bringing his/her mouth into contact with one region of the aerosol generating article 10 exposed to the outside of the housing 110 and inhale the aerosols discharged to the outside of the aerosol generating device 100.

The aerosol generating device 100 according to an embodiment may further include a cover 111 movably arranged in the housing 110 to open or close the insertion hole 110h. For example, the cover 111 may be slidably combined to the top surface of the housing 110 to expose the insertion hole 110h to the outside of the aerosol generating device 100 or cover the insertion hole 110h so that the insertion hole 110h is not exposed to the outside of the aerosol generating device 100.

According to an embodiment, the cover 111 may expose the insertion hole 110h to the outside of the aerosol generating device 100 at a first location (or an opening location). When the insertion hole 110h is exposed to the outside, the aerosol generating article 10 may be inserted into the housing 110 through the insertion hole 110h.

According to another embodiment, the cover 111 may cover the insertion hole 110h at a second location (or a closing location) so that the insertion hole 110h is not exposed to the outside of the aerosol generating device 100. Here, the cover 111 may prevent external impurities from entering into the heater assembly 200 through the insertion hole 110h when the aerosol generating device 100 is not used.

FIG. 1 illustrates only the aerosol generating device 100 for heating the aerosol generating article 10 in a solid state, but the aerosol generating device 100 is not limited thereto.

An aerosol generating device according to another embodiment may generate aerosols by heating an aerosol generating material in a liquid or gel state, instead of the aerosol generating article 10 in a solid state, through the heater assembly 200.

An aerosol generating device according to another embodiment may include the heater assembly 200 configured to heat the aerosol generating article 10 and a cartridge (or a vaporizer) including an aerosol generating material in a liquid or gel state and configured to heat the aerosol generating material. Aerosols generated from the aerosol generating material may move to the aerosol generating article 10 along an airflow passage communicated with the cartridge and the aerosol generating article 10 to each other and be mixed with aerosols generated from the aerosol generating article 10, and then transmitted to a user through the aerosol generating article 10.

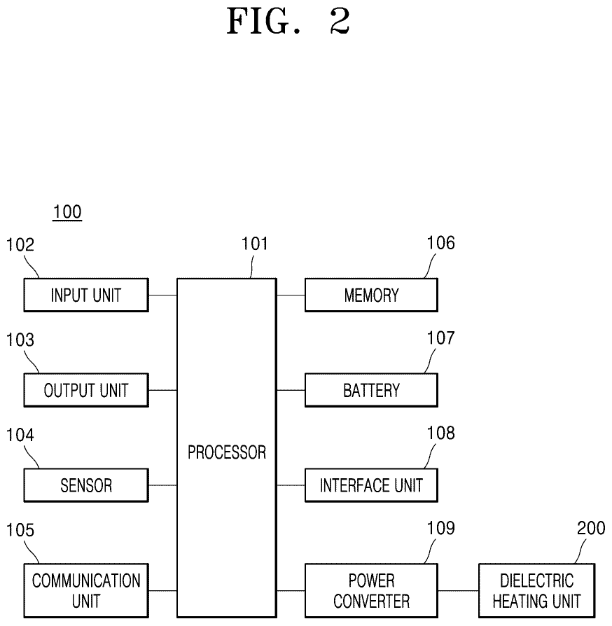

FIG. 2 is an internal block diagram of the aerosol generating device according to an embodiment.

Referring to FIG. 2, the aerosol generating device 100 may include an input unit 102, an output unit 103, a sensor 104, a communicator 105, a memory 106, a battery 107, an interface 108, a power converter 109, and a dielectric heater 200. However, an internal structure of the aerosol generating device 100 is not limited to those illustrated in FIG. 2. According to a design of the aerosol generating device 100, some of the components shown in FIG. 2 may be omitted or a new component may be added.

The input unit 102 may be configured to receive a user input. For example, the input unit 102 may be provided as a single pressurizing type push button. In another example, the input unit 102 may be a touch panel including at least one touch sensor. The input unit 102 may transmit an input signal to a processor 101. The processor 101 may supply power to the dielectric heater 200 based on the user input or output a user notification by controlling the output unit 103.

The output unit 103 may output information about a state of the aerosol generating device 100. The output unit 103 may output information about a charging/discharging state of the battery 107, a heating state of the dielectric heater 200, an insertion state of the aerosol generating article 10, and an error of the aerosol generating device 100. In this regard, the output unit 103 may include a display, a haptic motor, and a sound output unit.

The sensor 104 may sense a state of the aerosol generating device 100 or a state around the aerosol generating device 100, and transmit sensed information to the processor 101. Based on the sensed information, the processor 101 may control the aerosol generating device 100 to perform various functions, such as controlling heating of the dielectric heater 200, limiting smoking, determining whether the aerosol generating article 10 is inserted, displaying a notification, and the like.

The sensor 104 may include a temperature sensor, a puff sensor, and an insertion detection sensor.

The temperature sensor may detect a temperature inside the dielectric heater 200 in a non-contact manner or may directly obtain a temperature of a resonator by contacting the dielectric heater 200. According to an embodiment, the temperature sensor may detect a temperature of the aerosol generating article 10. Also, the temperature sensor may be arranged adjacent to the battery 107 to obtain a temperature of the battery 107. The processor 101 may control power supplied to the dielectric heater 200, based on temperature information of the temperature sensor.

The puff sensor may detect a puff of the user. The puff sensor may detect a puff of the user, based on at least one of a temperature change, a flow change, a power change, and a pressure change. The processor 101 may control power supplied to the dielectric heater 200, based on puff information of the puff sensor. For example, the processor 101 may count the number of puffs and block power supplied to the dielectric heater 200 when the number of puffs reaches a pre-set maximum number of puffs. In another example, the processor 101 may block power supplied to the dielectric heater 200 when a puff is not detected for a pre-set period of time or more.

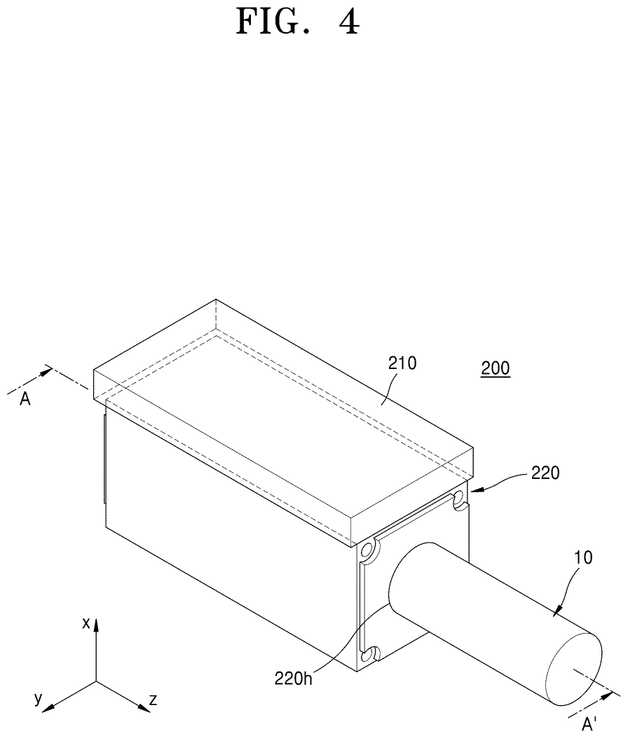

The insertion detection sensor may be arranged inside an accommodating space 220h of FIG. 4 or adjacent to the accommodating space 220h and detect insertion and removal of the aerosol generating article 10 accommodated in the insertion hole 110h. For example, the insertion detection sensor may include an inductive sensor and/or a capacitance sensor. The processor 101 may supply power to the dielectric heater 200 when the aerosol generating article 10 is inserted into the insertion hole 110h.

According to an embodiment, the sensor 104 may further include a reuse detection sensor, a motion detection sensor, a humidity sensor, an atmospheric pressure sensor, a magnetic sensor, a cover removal detection sensor, a location sensor (global positioning system (GPS)), and a proximity sensor. Because the functions of each sensor may be intuitively inferred by one of ordinary skill in the art from the name, detailed descriptions thereof will be omitted.

The communicator 105 may include at least one communication module for communication with an external electronic device. The processor 101 may control the communicator 105 to transmit information about the aerosol generating device 100 to the external electronic device. Alternatively, the processor 101 may receive information from the external electronic device through the communicator 105 to control the components included in the aerosol generating device 100. For example, information transmitted between the communicator 105 and the external electronic device may include user authentication information, firmware update information, and user smoking pattern information.

The memory 106 is hardware storing various types of data processed in the aerosol generating device 100, and may store data processed and data to be processed by the processor 101. For example, the memory 106 may store an operation time of the aerosol generating device 100, the maximum number of puffs, the current number of puffs, at least one temperature profile, data on the user's smoking pattern, and the like.

The battery 107 may supply power to the dielectric heater 200 such that the aerosol generating article 10 may be heated. Also, the battery 107 may supply power required for operations of other components included in the aerosol generating device 100. The battery 107 may be a rechargeable battery or a detachable and removable battery.

The interface 108 may include a connecting terminal that may be physically connected to the external electronic device. For example, the connecting terminal may include at least one or a combination of a high-definition multimedia interface (HDMI) connector, a universal serial bus (USB) connector, a secure digital (SD) card connector, and an audio connector (e.g., a headphone connector). The interface 108 may transmit or receive information to or from the external electronic device through the connecting terminal, or charge a power source.

The power converter 109 may convert direct current power supplied from the battery 107 into alternating current power. Also, the power converter 109 may provide the alternating current power to the dielectric heater 200. The power converter 109 may be an inverter including at least one switching device and the processor 101 may control on/off of the switching device included in the power convertor 109 to convert direct current power into alternating current power. The power converter 109 may be configured as a full-bridge or a half-bridge.

The dielectric heater 200 may heat the aerosol generating article 10 by using a dielectric heating method. The dielectric heater 200 may be a component corresponding to the heater assembly 200 of FIG. 1.

The dielectric heater 200 may heat the aerosol generating article 10 by using microwaves and/or an electric field of microwaves (hereinafter, referred to as microwaves or microwave power when distinction is not required). A heating method of the dielectric heater 200 may be a method of heating an object to be heated by forming microwaves in a resonance structure, instead of radiating microwaves by using an antenna. The resonance structure will be described below with reference to FIG. 4.

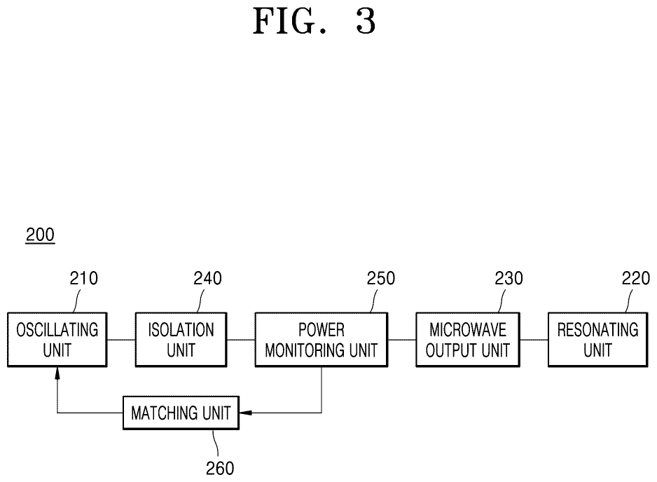

The dielectric heater 200 may output microwaves that is a high frequency to a resonator 220 of FIG. 3. Microwaves may be power in an industrial scientific and medical equipment (ISM) band allowed for heating, but are not limited thereto. The resonator 220 may be designed considering a wavelength of microwaves so that microwaves may resonate in the resonator 220.

The aerosol generating article 10 may be inserted into the resonator 220 and a dielectric material in the aerosol generating article 10 may be heated by the resonator 220. For example, the aerosol generating article 10 may include a polar material and molecules in the polar material may be polarized inside the resonator 220. The molecules may vibrate or rotate according to a polarization phenomenon and the aerosol generating article 10 may be heated by frictional heat generated during such a process. Details about the dielectric heater 200 will be described in detail below with reference to FIG. 3.

The processor 101 may control general operations of the aerosol generating device 100. The processor 101 may be implemented in an array of a plurality of logic gates, or in a combination of a general-purpose microprocessor and a memory storing a program executable by the general-purpose microprocessor. The processor 101 may be implemented in another form of hardware.

The processor 101 may control direct current power supplied from the battery 107 to the power converter 109 or alternating current power supplied from the power converter 109 to the dielectric heater 200, according to power demand of the dielectric heater 200. According to an embodiment, the aerosol generating device 100 may include a converter configured to boost or lower the direct current power, and the processor 101 may adjust a size of the direct current power by controlling the converter. Also, the processor 101 may control the alternating current power supplied to the dielectric heater 200 by adjusting a switching frequency and duty ratio of the switching device included in the power converter 109.

The processor 101 may control the heating temperature of the aerosol generating article 10 by controlling microwave power of the dielectric heater 200 and a resonating frequency of the dielectric heater 200. Accordingly, an oscillator 210, an isolator 240, a power monitoring unit 250, and a matching unit 260 of FIG. 3 described below may be some components of the processor 101.

The processor 101 may control microwave power of the dielectric heater 200, based on temperature profile information stored in the memory 106. In other words, a temperature profile may include information about a target temperature of the dielectric heater 200 according to time, and the processor 101 may control microwave power of the dielectric heater 200 according to time.

The processor 101 may adjust a frequency of microwaves so that the resonating frequency of the dielectric heater 200 is not uniform. The processor 101 may track, in real time, a change in the resonating frequency of the dielectric heater 200 according to the heating of an object to be heated, and control the dielectric heater 200 so that a microwave frequency according to the changed resonating frequency is output. In other words, the processor 101 may change the microwave frequency in real time regardless of the pre-stored temperature profile.

FIG. 3 is an internal block diagram of the dielectric heater 200 of FIG. 2.

Referring to FIG. 3, the dielectric heater 200 may include the oscillator, the isolator 240, the power monitoring unit 250, the matching unit 260, a microwave output unit 230, and the resonator 220. However, an internal configuration of the dielectric heater 200 is not limited to that shown in FIG. 3. According to a design of the dielectric heater 200, some of the components shown in FIG. 3 may be omitted or a new component may be added.

The oscillator 210 may receive alternating current power from the power converter 109 and generate microwave power of high frequency. According to an embodiment, the power converter 109 may be included in the oscillator 210. The microwave power may be selected from frequency bands of 915 MHz, 2.45 GHz, and 5.8 GHz, which are included in ISM bands.

The oscillator 210 may include a solid-state-based radio frequency (RF) generating apparatus and generate the microwave power by using the same. The solid-state-based RF generating apparatus may be implemented in a semiconductor. When the oscillator 210 is implemented in a semiconductor, the dielectric heater 200 may be miniaturized and device lifespan may be increased.

The oscillator 210 may output the microwave power towards the resonator 220. The oscillator 210 may include a power amplifier configured to increase or decrease the microwave power and the power amplifier may adjust a size of the microwave power according to control by the processor 101. For example, the power amplifier may decrease or increase amplitude of microwaves. The microwave power may be adjusted by adjusting the amplitude of microwaves.

The processor 101 may adjust the size of the microwave power output from the oscillator 210, based on a pre-stored temperature profile. For example, the temperature profile may include information about a target temperature according to a preheating period and a smoking period, and the oscillator 210 may supply the microwave power of first power during the preheating period and supply the microwave power of second power lower than the first power during the smoking period.

The isolator 240 may block the microwave power input from the resonator 220 towards the oscillator 210. The microwave power output by the oscillator 210 is mostly absorbed by an object to be heated, but part of the microwave power may be reflected at the object to be heated and transmitted back to the oscillator 210, depending on a heating pattern of the object to be heated. This is because impedance viewed from the oscillator 210 to the resonator 220 changes according to depletion of polar molecules due to heating of the object to be heated. The meaning that the impedance viewed from the oscillator 210 to the resonator 220 changes is the same as the meaning that the resonating frequency of the resonator 220 changes. The meaning that the impedance viewed from the oscillator 210 to the resonator 220 changes is the same as the meaning that the resonating frequency of the resonator 220 changes. The isolator 240 may not return the microwave power reflected at the resonator 220 back to the oscillator 210, but may induce the microwave power in a certain direction and absorb the same. In this regard, the isolator 240 may include a circulator and a dummy load.

The power monitoring unit 250 may monitor each of microwave power output from the oscillator 210 and reflection microwave power reflected at the resonator 220. The power monitoring unit 250 may transmit, to the matching unit 260, information about the microwave power and the reflection microwave power.

The matching unit 260 may match impedance viewed from the oscillator 210 to the resonator 220 with impedance viewed from the resonator 220 to the oscillator 210, so that the reflection microwave power is minimized. Impedance matching may have a same meaning as matching a frequency of the oscillator 210 and the resonating frequency of the resonator 220. Accordingly, to match the impedance, the matching unit 260 may vary a frequency of the oscillator 210. In other words, the matching unit 260 may adjust a frequency of the microwave power output from the oscillator 210 so that the reflection microwave power is minimized. The impedance matching of the matching unit 260 may be performed in real time regardless of the temperature profile.

The oscillator 210, the isolator 240, the power monitoring unit 250, and the matching unit 260 are separate components distinguished from the microwave output unit 230 and the resonator 220 described below, and may be implemented as a microwave source in the form of a chip. Also, according to an embodiment, the oscillator 210, the isolator 240, the power monitoring unit 250, and the matching unit 260 may be implemented as a partial configuration of the processor 101.

The microwave output unit 230 is a component configured to input the microwave power to the resonator 220 and may correspond to a coupler of FIG. 3 and below. The microwave output unit 230 may be implemented in the form of a SubMiniature Version A (SMA), SubMiniature Version B (SMB), Micro Coaxial (MCX), or Micro-Miniature Coaxial (MMCX) connector. The microwave output unit 230 may connect the resonator 220 to the microwave source in the form of a chip so as to transmit microwave power generated in the microwave source to the resonator 220.

The resonator 220 may heat the object to be heated by forming microwaves in a resonance structure. The resonator 220 may include an accommodating space in which the aerosol generating article 10 is accommodated and the aerosol generating article 10 may be dielectrically heated by being exposed to microwaves. For example, the aerosol generating article 10 may include a polar material and molecules in the polar material may be polarized inside the resonator 220 by microwaves. The molecules may vibrate or rotate according to a polarization phenomenon and the aerosol generating article 10 may be heated by frictional heat generated during such a process.

The resonator 220 includes at least one internal conductor for microwaves to resonate, and the microwaves may resonate inside the resonator 220 according to an arrangement, thickness, and length of the internal conductor.

The resonator 220 may be designed in consideration of the wavelength of the microwave such that the microwave may be resonated in the resonator 220. For the microwave to be resonated in the resonator 220, the resonator 220 needs a closed end/short end, in which a cross-section thereof is closed, and an open end opposite to the closed end/short end, wherein at least a region of a cross-section of the open end is open. In addition, it is required that a length between the closed end/short end and the open end is set as an integer multiple of ¼ of the wavelength of the microwave. To reduce the size of the aerosol generating device 100, a ¼ length of the wavelength of the microwave is selected for the resonator 220 of the disclosure. In other words, the length between the closed end/short end and the open end of the resonator 220 may be set as the length of ¼ of the wavelength of the microwave.

The resonator 220 may include a dielectric material-accommodation space. In the dielectric material-accommodation space, which is a component distinguished from the accommodation space of the aerosol generating article 10, a material capable of changing the resonance frequency of an entire portion of the resonator 220 and reducing a size of the resonator 220 is arranged. In an embodiment, a dielectric material having a low microwave absorbance may be accommodated in the dielectric material-accommodation space. This is to prevent heating of the dielectric material itself caused as energy to be delivered to the heating object is delivered to the dielectric material. The absorbance of the microwave may be expressed as the loss tangent, i.e., the ratio of the imaginary part of the complex dielectric constant to the real part of the complex dielectric constant. In an embodiment, a dielectric material having a loss tangent equal to a preset value or smaller may be accommodated in the dielectric material-accommodation space 227, and the preset value may be 1/100. For example, the dielectric may include at least one of quartz, tetrafluoroethylene, and aluminum oxide, or a combination thereof, but is not limited thereto.

Referring to FIG. 4, a heater assembly 200 according to an embodiment may include an oscillating unit 210 and a resonating unit 220.

FIG. 4 may illustrate an embodiment of the heater assembly 200 and the dielectric heating unit 200 described above, and redundant descriptions thereof are omitted below.

The oscillating unit 210 may generate microwaves in a designated frequency band as power is supplied. The microwaves generated by the oscillating unit 210 may be transmitted to the resonating unit 220 through a coupler 230.

The resonating unit 220 may include an accommodation space 220h for accommodating at least one region of an aerosol generating article 10 and may heat the aerosol generating article 10 through a dielectric heating method by resonating the microwaves generated by the oscillating unit 210. For example, electric charges of glycerin included in the aerosol generating article 10 may vibrate or rotate due to the resonance of the microwaves, and heat may be generated from the glycerin due to frictional heat generated when the electric charges vibrate or rotate, and accordingly, the aerosol generating article 10 may be heated.

According to one embodiment, the resonating unit 220 may be formed of a material with a low microwave absorption rate to prevent the microwaves generated by the oscillating unit 210 from being absorbed by the resonating unit 220.

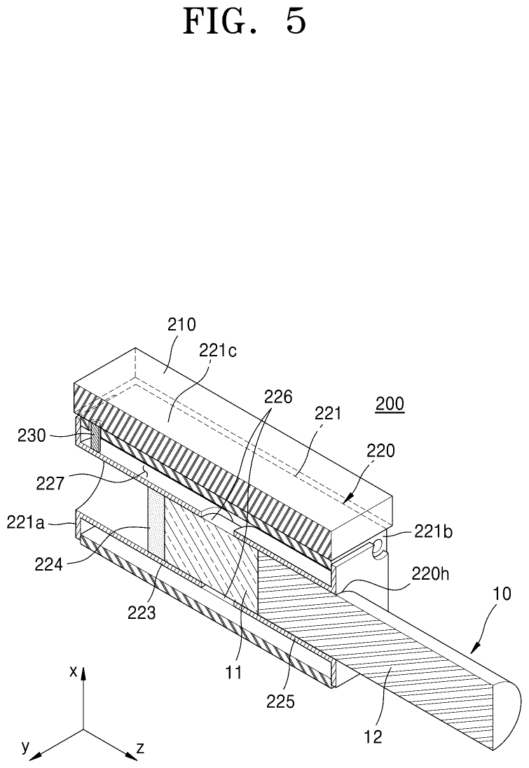

Hereinafter, a specific structure of the resonating unit 220 of the heater assembly 200 is described with reference to FIG. 5.

FIG. 5 is a cross-sectional view of the heater assembly 200 of FIG. 4. FIG. 5 illustrates a cross-section of the heater assembly 200 which is taken along line A-A′ of FIG. 4.

Referring to FIG. 5, the heater assembly 200 according to an embodiment may include the oscillating unit 210, the resonating unit 220, and the coupler 230. Components of the heater assembly 200 may be identical or similar to at least one of the components of the heater assembly 200 of FIG. 4, and accordingly, redundant descriptions thereof are omitted below.

The oscillating unit 210 may generate microwaves in a designated frequency band as an alternating current (AC) voltage is applied thereto, and the microwaves generated by the oscillating unit 210 may be transmitted to the resonating unit 220 through the coupler 230.

According to one embodiment, the oscillating unit 210 may be fixed to the resonating unit 220 to prevent separation from the resonating unit 220 during the use of an aerosol generating device. In one example, the oscillating unit 210 may be fixed on the resonating unit 220 in a region facing the x direction of the resonating unit 220. The oscillating unit 210 may be fixed on the resonating unit 220 by a bracket or so on provided in one region of the resonating unit 220. Alternatively, the oscillating unit 210 may be fixed on the resonating unit 220 in a manner of being directly attached to one region of the resonating unit 220.

Although FIG. 5 illustrates only an embodiment in which the oscillating unit 210 is fixed to one region of the resonating unit 220 facing the x direction, a position of the oscillating unit 210 is not limited to the illustrated embodiment. In another embodiment, the oscillating unit 210 may be fixed to another region facing the-z direction of the resonating unit 220.

The resonating unit 220 may surround at least one region of the aerosol generating article 10 inserted into the aerosol generating device and may heat the aerosol generating article 10 through microwaves generated by the oscillating unit 210. For example, dielectric materials included in the aerosol generating article 10 may be heated by an electric field generated inside the resonating unit 220 due to the microwaves, and the aerosol generating article 10 may be heated by the heat generated from the dielectric.

According to one embodiment, the aerosol generating article 10 may include a tobacco rod 11 and a filter rod 12.

The tobacco rod 11 includes an aerosol generation material and may be manufactured as a sheet or strand or as tobacco cut sheets cut into small pieces. For example, the aerosol generation material may include at least one of glycerin, propylene glycol, ethylene glycol, dipropylene glycol, diethylene glycol, triethylene glycol, tetraethylene glycol, and oleyl alcohol but is not limited thereto. Also, the tobacco rod 11 may include another additive, such as a flavoring agent, a humectant, and/or organic acid. Also, a flavoring liquid, such as menthol or a humectant, may be added to the tobacco rod 11 by being sprayed onto the tobacco rod 11.

The filter rod 12 may be a cellulose acetate filter. In addition, there is no limitation on a shape of the filter rod 12. For example, the filter rod 12 may be a cylindrical rod or a tube-type rod having a hollow portion therein. Also, the filter rod 12 may be a recessed rod. When the filter rod 12 includes a plurality of segments, at least one of the plurality of segments may be made in a different shape.

At least a part of the aerosol generation material (for example, glycerin) included in the aerosol generating article 10 may be a dielectric having polarity in an electric field, and at least a part of the aerosol generation material may generate heat through a dielectric heating manner to heat the aerosol generating article 10.

According to one embodiment, the resonating unit 220 may include an outer conductor 221, a first inner conductor 223, and a second inner conductor 225.

The outer conductor 221 may form the entire appearance of the resonating unit 220 and may have a hollow shape of which inside is empty, and accordingly, components of the resonatingfr unit 220 may be arranged inside the outer conductor 221. The outer conductor 221 may include an accommodation space 220h in which the aerosol generating article 10 may be accommodated, and the aerosol generating article 10 may be inserted into the outer conductor 221 through the accommodation space 220h.

According to one embodiment, the outer conductor 221 may have a first surface 221a, a second surface 221b facing the first surface 221a, and a side surface 221c surrounding a space between the first surface 221a and the second surface 221b. At least some of components of the resonating unit 220 (for example, the first inner conductor 223 and the second inner conductor 225) may be arranged in an inner space of the resonating unit 220 formed by the first surface 221a, the second surface 221b, and the side surface 221c.

The first inner conductor 223 may be formed in a hollow cylindrical shape extending in a direction from the first surface 221a of the outer conductor 221 toward an inner space of the outer conductor 221.

According to one embodiment, one region of the first inner conductor 223 may be in contact with the coupler 230 connected to the oscillating unit 210, and the microwaves generated by the oscillating unit 210 may be transmitted to the first inner conductor 223 through the coupler 230. For example, the coupler 230 may pass through the outer conductor 221, one end of coupler 230 may be in contact with the oscillating unit 210, and the other end of the coupler 230 may be in contact with one region of the first inner conductor 223, and the microwaves generated by the oscillating unit 210 may be transmitted to the first inner conductor 223 through the coupler 230.

In this case, the coupler 230 may pass through the outer conductor 221 to transmit microwaves without being in contact with the outer conductor 221, but in a case where the microwaves generated by the oscillating unit 210 may be transmitted to the first inner conductor 223, an arrangement structure of the coupler 230 is not limited thereto.

A first region between the outer conductor 221 and the first inner conductor 223 may operate as a “first resonator” that generates an electric field through resonance of microwaves. The first region may refer to a space formed by the first surface 221a and the side surface 221c of the outer conductor 221 and the first inner conductor 223, and the microwaves transmitted through the coupler 230 may resonate to generate an electric field in the first region.

The coupler 230 is not limited to the illustrated form as long as the coupler 230 may transmit microwaves of the oscillating unit 210 to the resonating unit 220.

The second inner conductor 225 may have a hollow cylindrical shape extending from the second surface 221b of the outer conductor 221 toward an inner space of the outer conductor 221. The second inner conductor 225 may be arranged in the inner space of the outer conductor 221 at a predetermined distance from the first inner conductor 223, and a gap 226 may be formed between the first inner conductor 223 and the second inner conductor 225.

A second region between the outer conductor 221 and the second inner conductor 225 may operate as a “second resonator” that generates an electric field through resonance of microwaves. The second inner conductor 225 may be coupled (for example, capacitively coupled) to the first inner conductor 223, and when an electric field is generated inside the first region by the coupling relationship described above, an induced electric field may also be generated inside the second region. In the present disclosure, “capacitive coupling” may refer to a coupling relationship in which energy may be transferred by electrostatic capacity (capacitance) between two conductors.

For example, as the microwaves generated by the oscillating unit 210 are transmitted to the first inner conductor 223, an electric field may be generated inside the first region by resonance, and an induced electric field may be generated inside the second region formed by the outer conductor 221 and the second inner conductor 225 coupled to the first inner conductor 223.

According to one embodiment, the first region and the second region of the resonating unit 220 may operate as a resonator having a quarter of a wavelength A of a microwave.

In one example, one end (for example, an end in the-z direction) of the first region may be formed as a closed end/short end because a cross-section of the first region is closed by the first surface 221a of the outer conductor 221, and the other end (for example, an end in the z direction) of the first region may be formed as an open end because a cross-section is open due to the first surface 221a which is not arranged. In another example, one end (for example, an end in the-z direction) of the second region may be formed as an open end because a cross-section is open, and the other end (for example, an end in the z direction) of the second region may be formed as a closed end/short end because a cross-section of the second region is closed by the second surface 221b of the outer conductor 221.

That is, the first region and the second region may be formed as a “⊏” shape overall, including the closed/short end and the open end, when viewed on an x-z plane, and through the above-described structure, the first region and the second region may operate as a resonator having a quarter of a wavelength of a microwave.

According to one embodiment, the first inner conductor 223 and the second inner conductor 225 may be formed to have the same length based on the z axis, such that the first region and the second region may be arranged symmetrically to each other, but the present disclosure is not limited thereto.

The aerosol generating article 10 inserted into the outer conductor 221 through the accommodation space 320h may be surrounded by the first inner conductor 223 and the second inner conductor 225 and heated through a dielectric heating method.

At least a part of the electric field generated due to resonance of microwaves in the first region and/or the second region may be propagated toward the inside of the first inner conductor 223 and/or the second inner conductor 225 through the gap 226 between the first inner conductor 223 and the second inner conductor 225, and the aerosol generating article 10 surrounded by the first inner conductor 223 and the second inner conductor 225 may be heated by the propagated electric field. For example, a dielectric included in the aerosol generating article 10 may be heated by the electric field propagated through the gap 226, and the aerosol generating article 10 may be heated by the heat generated by the dielectric.

According to one embodiment, the heater assembly 200 may prevent an electric field transmitted into the inside of the first inner conductor 223 and/or the second inner conductor 225 from leaking out of the heater assembly 200 or the resonating unit 220 by setting diameters of the first inner conductor 223 and the second inner conductor 225 to be less than a designated value.

In the present disclosure, the “designated value” may refer to a diameter value at which an electric field begins to leak out of the first inner conductor 223 and/or the second inner conductor 225. For example, when the diameter of at least one of the first inner conductor 223 and the second inner conductor 225 is greater than a designated value, a situation may occur in which a part of the electric field introduced into the first inner conductor 223 and/or the second inner conductor 225 leaks out of the resonating unit 220.

In addition, the heater assembly 200 according to an embodiment may prevent the electric field from being transmitted to the outside of the resonating unit 220 through a structure in which the diameters of the first inner conductor 223 and the second inner conductor 225 are less than a designated value, and as a result, the electric field may be prevented from leaking to the outside of the heater assembly 200 or the resonating unit 220 without a separate shielding member.

According to one embodiment, when the aerosol generating article 10 is inserted into the resonating unit 220 through the accommodation space 220h, the tobacco rod 11 of the aerosol generating article 10 may be arranged at a position corresponding to the gap 226 between the first inner conductor 223 and the second inner conductor 225.

As the electric field generated by the first region and the electric field generated by the second region are introduced into the first inner conductor 223 and/or the second inner conductor 225 through the gap 226, the strongest electric field may be generated in a peripheral region of the gap 226 among inner regions of the resonating unit 220. According to one embodiment, the heater assembly 200 may increase heating efficiency (or “dielectric heating efficiency”) of the heater assembly 200 by arranging the tobacco rod 11 including a dielectric that generates heat by the electric field at a position corresponding to the gap 226 where the electric field is the strongest.

According to one embodiment, the resonating unit 220 may further have a closed portion 224 located inside the first inner conductor 223 and closing a cross-section of the first inner conductor 223 to restrict a flow direction of the aerosol generated by the aerosol generating article 10. For example, the closed portion 224 may close a cross-section of the first inner conductor 223 to block the flow of an aerosol generated from the aerosol generating article 10 in the −z direction.

When the aerosol generated by the aerosol generating article 10 or the droplets generated when the aerosol is liquefied flow in the −z direction and flow into other components of the aerosol generating device (for example, the aerosol generating device 100 of FIG. 1), components of the aerosol generating device may malfunction or may be damaged. In addition, the heater assembly 200 according to an embodiment may prevent malfunction or damage to the components of the aerosol generating device due to the aerosol or droplets by restricting a flow direction of the aerosol through the closed portion 224.

According to one embodiment, the resonating unit 220 may further include a dielectric accommodation space 227 for accommodating a dielectric. The dielectric accommodation space 227 may refer to a free space among the outer conductor 221, the first inner conductor 223, and the second inner conductor 225, and a dielectric with a low microwave absorption may be accommodated in the dielectric accommodation space 227. For example, the dielectric may be at least one of quartz, tetrafluoroethylene, and aluminum oxide, or a combination thereof but is not limited thereto.

The heater assembly 200 according to an embodiment may generate an electric field similar to an electric field of a resonating unit 220 that does not include a dielectric while reducing the entire size of the resonating unit 220 by arranging the dielectric inside the dielectric accommodation space 227. That is, the heater assembly 200 according to an embodiment may reduce a mounting space of the resonating unit 220 in the aerosol generating device by reducing a size of the resonating unit 220 through a dielectric arranged inside the dielectric accommodation space 227, and as a result, the aerosol generating device may be reduced in size.

In addition, the oscillating unit 210 may be arranged on one surface of the outer conductor 221 of the resonating unit 220. The oscillating unit 210 may cover at least a part of one surface of the outer conductor 221 or completely cover the one surface of the outer conductor 221, and may be larger than a size that covers the one surface of the outer conductor 221. As illustrated in FIG. 5, the oscillating unit 210 may be arranged on the side surface 221c (for example, in the +x direction) of the outer conductor 221.

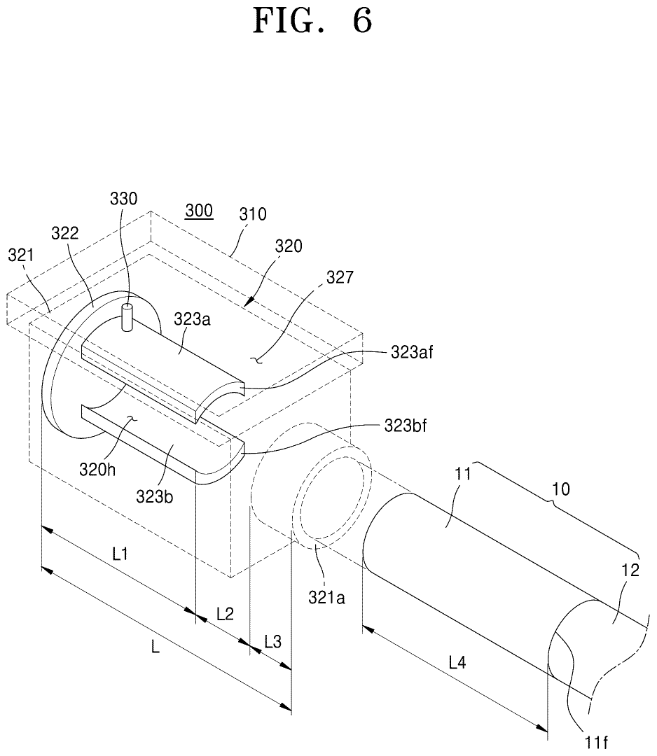

FIG. 6 is a perspective view schematically illustrating a heater assembly according to another embodiment.

A heater assembly 300 according to the embodiment illustrated in FIG. 6 may include an oscillating unit 310 that generates microwaves, a resonating unit 320 that generates an electric field by resonating the microwaves generated by the oscillating unit 310, and a coupler 330 that transmits the microwaves to the resonating unit 320.

The resonating unit 320 may include a case 321, a first plate 323a, a second plate 323b, and a connector 322 that connects the first plate 323a and the second plate 323b to the case 321.

The coupler 330 may supply microwaves to at least one of the first plate 323a and the second plate 323b to generate microwave resonance in the resonating unit 320.

The resonating unit 320 may surround at least one region of the aerosol generating article 10 inserted into an aerosol generating device. The coupler 330 may supply the microwaves generated by an oscillating unit 310 to the resonating unit 320. When microwaves are supplied to the resonating unit 320, microwave resonance occurs in the resonating unit 320, and accordingly, the resonating unit 320 may heat the aerosol generating article 10. For example, dielectrics included in the aerosol generating article 10 may be heated by an electric field generated inside the resonating unit 320 by microwaves, and the aerosol generating article 10 may be heated by the heat generated by the dielectrics.

The case 321 of the resonating unit 320 functions as an “outer conductor”. The case 321 has a hollow shape in which the inside of the case 321 is empty, and accordingly, components of the resonating unit 320 may be arranged inside the case 321.

The case 321 may include an accommodation space 320h in which the aerosol generating article 10 may be accommodated, and an opening 321a into which the aerosol generating article 10 may be inserted. The opening 321a may be connected to the accommodation space 320h. The opening 321a is opened toward the outside of the case 321, and accordingly, the accommodation space 320h may be connected to the outside through the opening 321a. Therefore, the aerosol generating article 10 may be inserted into the accommodation space 320h of the case 321 through the opening 321a of the case 321.

Although FIG. 6 illustrates that the case 321 has a square cross-sectional shape, the shape of the case 321 may be changed to various shapes. For example, a case 321 may have one of various cross-sectional shapes, such as a rectangle, an ellipse, or a circle. The case 321 may extend in one direction.

The first plate 323a and the second plate 323b that may function as an “internal conductor” of the resonating unit 320 may be arranged inside the case 321.

The first plate 323a and the second plate 323b may be arranged to be separated from each other in a circumferential direction of the aerosol generating article 10 accommodated in the accommodation space 320h. The first plate 323a surrounds one region of the aerosol generating article 10, and the second plate 323b surrounds another region of the aerosol generating article 10.

The first plate 323a and the second plate 323b may be connected to the case 321 through the connector 322. Also, one end of the first plate 323a may be connected to one end of the second plate 323b by the connector 322. Therefore, closed ends may be formed at ends of the first plate 323a and the second plate 323b by the connector 322.

An end 323af of the first plate 323a and an end 323bf of the second plate 323b may be separated from each other and be opened. Because the ends 323af and 323bf are separated from each other, open ends may be formed at the other ends of the first plate 323a and the second plate 323b.

A resonator assembly may be completed by connecting the first plate 323a and the second plate 323b to the connector 322. A shape of a cross-section taken along a longitudinal direction of the resonator assembly may include a “horseshoe-shape”.

The first plate 323a and the second plate 323b may extend toward a longitudinal direction of the aerosol generating article 10. At least a part of each of the first plate 323a and the second plate 323b may be curved to protrude outwardly from the center of the longitudinal direction of the aerosol generating article 10.

For example, when the aerosol generating article 10 has a cylindrical shape, the first plate 323a and the second plate 323b may be curved in a circumferential direction along an outer circumferential surface of the aerosol generating article 10. A radius of curvature of a cross-section of each of the first plate 323a and the second plate 323b may be equal to a radius of curvature of the aerosol generating article 10. The radius of curvature of the cross-section of each of the first plate 323a and the second plate 323b may be variously modified. For example, the radius of curvature of the cross-section of each of the first plate 323a and the second plate 323b may be greater or less than the radius of curvature of the aerosol generating article 10.

According to the structure in which the first plate 323a and the second plate 323b are curved in a circumferential direction along an outer circumferential surface of the aerosol generating article 10, a more uniform electric field is formed in the resonating unit 320, and accordingly, the heater assembly 300 may uniformly heat the aerosol generating article 10.

The open ends of the ends 323af and 323bf of the first plate 323a and the second plate 323b may face the opening 321a of the case 321. The opening 321a of the case 321 may be separated from the ends 323af and 323bf of the first plate 323a and the second plate 323b to be far away therefrom.

The open ends of the ends 323af and 323bf of the first plate 323a and the second plate 323b may be aligned with respect to the opening 321a of the case 321. Therefore, when the aerosol generating article 10 is inserted into the accommodation space 320h through the opening 321a of the case 321, a part of the aerosol generating article 10 which is placed in the accommodation space 320h may be surrounded by the first plate 323a and the second plate 323b.

The first plate 323a and the second plate 323b are arranged on an opposite side of the center of a longitudinal direction of the aerosol generating article 10. The embodiments are not limited to the number of the first plate 323a and the second plate 323b, and the number of the first plate 323a and the second plate 323b may be, for example, three, four, or more.

The first plate 323a and the second plate 323b may be arranged to be symmetrical to a central axis of a longitudinal direction of the aerosol generating article 10, that is, a direction in which the aerosol generating article 10 extends.

At least one of the first plate 323a and the second plate 323b may be in contact with the coupler 330 connected to an oscillating unit 310. The resonating unit 320 may include a case 321, a plurality of plates 323a and 323b, and a connector 322 that connects the first plate 323a and the second plate 323b to the case 321. When the microwave is transmitted to the first plate 323a through the coupler 330, microwave resonance may be formed between the first plate 323a and the second plate 323b. Also, microwave resonance may be formed between the first plate 323a and an upper plate of the case 321 and between the second plate 323b and a lower plate of the case 321. Therefore, an electric field may be generated between the first and second plates 323a and 323b and the connector 322, between the first plate 323a and the upper plate of the case 321, and between the second plate 323b and the lower plate of the case 321.

The coupler 330 may pass through the case 321, and accordingly, one end of the coupler 330 may be in contact with an oscillating unit 310, and the other end of the coupler 330 may be in contact with one region of the first plate 323a. As the microwaves generated by the oscillating unit 310 are transmitted to the first plate 323a and the second plate 323b and the connector 322 through the coupler 330, an electric field may be generated inside an assembly of the first plate 323a and the second plate 323b and the connector 322.

Also, according to a structure of the resonating unit 320 of the heater assembly 300, a triple resonance mode may be formed in the resonating unit 320. Resonance of a transverse electric & magnetic (TEM) mode of microwaves is formed between the first plate 323a and the second plate 323b. Also, resonances of the TEM mode different from the resonance formed between the first plate 323a and the second plate 323b may be formed respectively between the first plate 323a and an upper plate of the case 321 and between the second plate 323b and a lower plate of the case 321. The resonating unit 320 of FIG. 6 enables TEM mode resonance formed by the first plate 323a and the second plate 323b, and accordingly, the resonating unit 320 may be manufactured to have a smaller size than the resonating unit 220 of FIG. 5 which only enables transverse electric (TE) resonance and transverse magnetic (TM) mode.

As triple resonance is generated in the resonating unit 320 of the heater assembly 300, the aerosol generating article 10 may be heated more effectively and uniformly.

The resonating unit 320 according to the embodiment described above may include a closed end/short end of which cross-section is closed to have a quarter length Q/4 of a wavelength of a microwave, and an open end of which cross-section is in an opposite direction to the closed end/short end and at least one region is opened.

In FIG. 6, a region of one end of the resonating unit 320 corresponding to a left region forms a closed end/short end closed by a structure in which one end of each of the first plate 323a and the second plate 323b and the connector 322 are connected to the case 321. In FIG. 6, a region of the other end of the resonating unit 320 corresponding to a right region forms an open end by opening the opening 321a of the case 321 to the outside. With the structure of the resonating unit 320, the resonating unit 320 may operate as a resonator having a quarter wavelength of a microwave.

According to a resonance structure of the resonating unit 320 described above, an electric field may not be transferred to an external region of the resonating unit 320. Therefore, the heater assembly 300 may prevent an electric field from leaking to the outside of the heater assembly 300 even without a separate shielding member for shielding the electric field.

The aerosol generating article 10 inserted into the accommodation space 320h of the case 321 may be surrounded by the first plate 323a and the second plate 323b to be heated by a dielectric heating method. For example, a part including a medium of the aerosol generating article 10 inserted into the accommodation space 320h of the case 321 may be arranged in a space between the first plate 323a and the second plate 323b. The aerosol generating article 10 may be heated when a dielectric included in the aerosol generating article 10 is heated by an electric field generated in a space between the first plate 323a and the second plate 323b.

Also, a secondary heating may be performed on the aerosol generating article 10 by the electric field due to the resonance mode formed between the first plate 323a and the upper plate of the case 321 and between the second plate 323b and the lower plate of the case 321.

When the aerosol generating article 10 is inserted into the resonating unit 320 through the accommodation space 320h, the tobacco rod 11 of the aerosol generating article 10 may be placed between the first plate 323a and the second plate 323b.

A length L4 of the tobacco rod 11 may be greater than a lengths L1 of each of the first plate 323a and the second plate 323b. Therefore, a front end 11f of the tobacco rod 11 in contact with the filter rod 12 may be placed at a position that protrudes more than the other end 323af of the first plate 323a and the other end 323bf of the second plate 323b in a direction toward the opening 321a of the case 321.

A resonance peak may be formed at the other end of each of the first plate 323a and the second plate 323b that operate as resonators, and accordingly, a stronger electric field may be generated compared to other regions. When the aerosol generating article 10 is inserted into the heater assembly 300, the tobacco rod 11 including a dielectric that may generate heat by an electric field may be arranged to correspond to a region where an electric field is strongest, and accordingly, heating efficiency (or “dielectric heating efficiency”) of the heater assembly 300 may be increased.

Referring to FIG. 6, the length L1 of each of the first plate 323a and the second plate 323b may be less than a length L1+L2 of an internal space of the case 321. Therefore, the other ends of the first plate 323a and the second plate 323b may be placed inside the case 321 rather than the opening 321a. That is, the other ends of the first plate 323a and the second plate 323b may be separated from a rear end of the opening 321a by a distance L2.

A length from the rear end of the opening 321a where the opening 321a is connected to the case 321 to a front end of the opening 321a where the opening 321a is opened may be L3. A total length of the case 321 in the longitudinal direction of the case 321 may be L. An entire length L of the case 321 may be determined by the sum of the length L1 of each of the first plate 323a and the second plate 323b, the length L2 which is a separated distance between the rear end of the opening 321a and the first and second plates 323a and 323b, and the length L3 of a protrusion of the opening 321a from the case 321.

In order to prevent leakage of microwaves, the front end of the opening 321a in which the opening 321a is opened is placed at a position in which the opening 321a protrudes from the case 321 by the length of L3. As the opening 321a of the case 321 protrudes from the case 321, the opening 321a may function to prevent microwaves inside the case 321 of the resonating unit 320 from leaking to the outside of the case 321.

The resonating unit 320 may further include a dielectric accommodation space 327 for accommodating a dielectric. The dielectric accommodation space 327 may be formed in a free space between the case 321 and the first and second plates 323a and 323b. A dielectric with a low microwave absorbance may be accommodated in the dielectric accommodation space 327.

By arranging a dielectric inside the dielectric accommodation space 327, the entire size of the resonating unit 320 may be reduced, and an electric field at the same level as the electric field generated by the resonating unit that does not include a dielectric may be generated. That is, a mounting space of the resonating unit 320 in an aerosol generating device may be reduced by reducing a size of the resonating unit 320 through a dielectric arranged inside the dielectric accommodation space 327, and as a result, the aerosol generating device may be miniaturized.

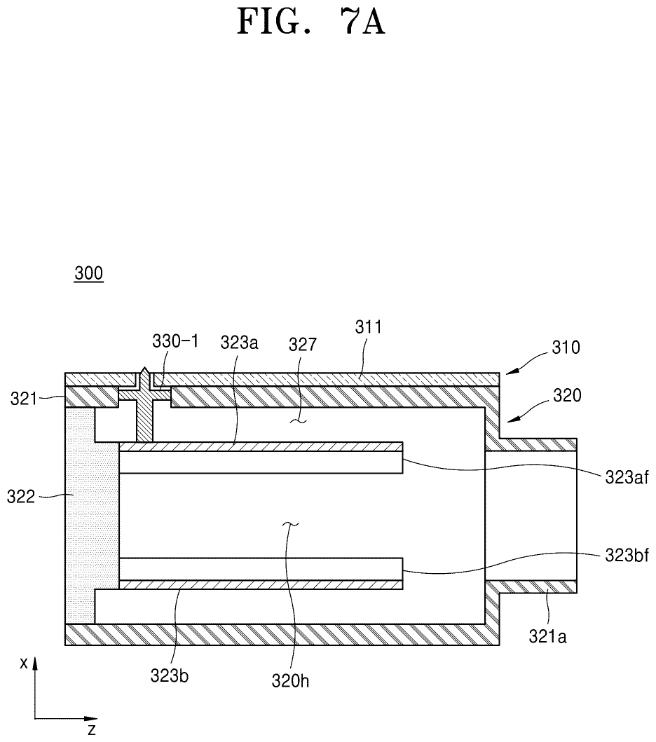

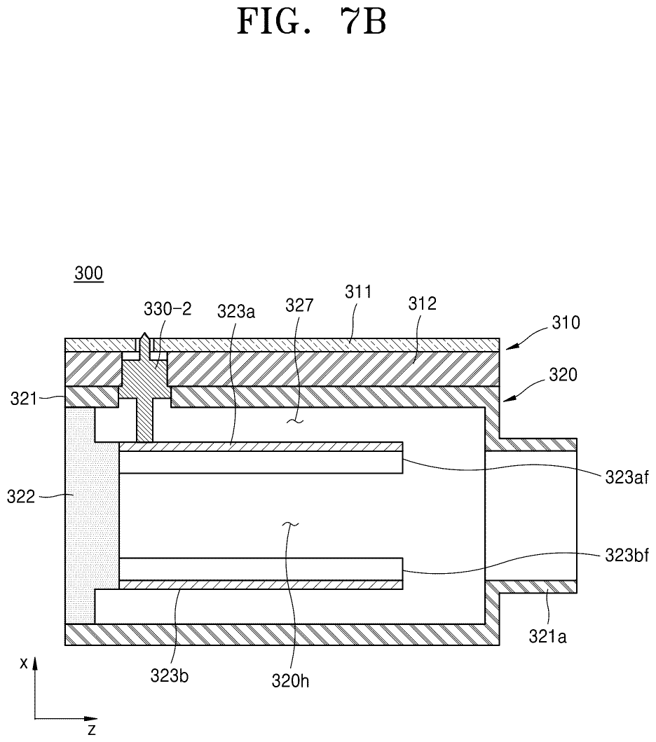

Hereinafter, specific structures of the oscillating unit 310 of the heater assembly 300 are described with reference to FIGS. 7A and 7B.

FIG. 7A and FIG. 7B are cross-sectional views of heater assemblies according to another embodiment. Components of FIG. 7A and FIG. 7B may be identical or similar to at least one of components of the heater assembly 300 of FIG. 6, and accordingly, redundant descriptions thereof are omitted below.

A heater assembly 300 according to an embodiment may include an oscillating unit 310 arranged on a surface of a resonating unit 320. For example, the oscillating unit 310 may be stacked on one surface (for example, in the +x direction) of the resonating unit 320. In addition, the heater assemblies 300 may respectively include couplers 330-1 and 330-2 that transmit microwaves generated by the oscillating unit 310 to the resonating unit 320.

The coupler 330-1 transmits the microwaves generated by the oscillating unit 310 to the resonating unit 320 and may be arranged such that one end of the coupler 330-1 is in contact with the oscillating unit 310 and the other end of the coupler 330-1 is in contact with the resonating unit 320. For example, one end of the coupler 330-1 may be in contact with a printed circuit board 311 of the oscillating unit 310, and the other end of the coupler 330-1 may be in contact with one region of a first plate 323a of the resonating unit 320. The couplers 330-1 and 330-2 may be extended to the oscillating unit 310, and the couplers 330-1 and 330-2 and the oscillating unit 310 may be bonded to each other by a conductive material (not illustrated) but are not limited thereto.

Although FIGS. 7A and 7B illustrated that one end of each of the couplers 330-1 and 330-2 passes through the oscillating unit 310 to protrude on a surface of the oscillating unit 310, but shapes of the couplers 330-1 and 330-2 are not limited thereto and change.

Referring to FIG. 7A, the oscillating unit 310 may include a printed circuit board (PCB) 311, and the printed circuit board 311 may be arranged on a surface of the resonating unit 320.

According to an embodiment, the oscillating unit 310 may be fixed to the resonating unit 320. For example, the oscillating unit 310 may be fixed on one surface of the resonating unit 320. The oscillating unit 310 may be in direct contact with the resonating unit 320.

The oscillating unit 310 may be stacked on one surface of the resonating unit 320, and thus, a size of the heater assembly 300 may be reduced. In addition, by having the above-described structure, the oscillating unit 310 may be in surface contact with the resonating unit 320, and the resonating unit 320 itself may serve as a heat dissipation member. The resonating unit 320 generates little heat and may have an excellent heat dissipation effect because a surface of the resonating unit 320 is formed of metal.

The oscillating unit 310 may include the printed circuit board 311. The printed circuit board 311 may dissipate the heat generated by components of the printed circuit board 311 through the resonating unit 320 by being in direct contact with the resonating unit 320.

The oscillating unit 310 may be soldered onto the surface of the resonating unit 320. For example, the printed circuit board 311 of the oscillating unit 310 may be soldered onto the surface of the resonating unit 320. Soldering is a method of bonding different metals to each other and may bond and connect components formed of different metal materials by heating and melting a solder and then cooling the solder. The solder may bond the resonating unit 320 to the printed circuit board 311 by being melted and cooled between the resonating unit 320 and the printed circuit board 311.

When a connector is used to connect the oscillating unit 310 to the resonating unit 320, there is a high possibility that a space is left between a component of the oscillating unit 310 and a component of the resonating unit 320 due to the connector. However, according to the heater assembly 300 of the embodiment, the oscillating unit 310 may be directly bonded onto the resonating unit 320, and thus, an aerosol generating device may be miniaturized.

The printed circuit board 311 may be formed in a size and shape similar to a size and shape corresponding to a surface of the stacked resonating unit 320. However, the size and shape of the printed circuit board 311 may be modified in various ways.

Referring to FIG. 7B, the oscillating unit 310 may further include a heat dissipation plate 312. For example, the heat dissipation plate 312 may be between the printed circuit board 311 and the resonating unit 320. Accordingly, the heat dissipation plate 312 may be arranged on a surface of the resonating unit 320, and the printed circuit board 311 may be arranged on a surface of the heat dissipation plate 312.

The heat dissipation plate 312 may be between the printed circuit board 311 and the resonating unit 320 and increase an effect of dissipating heat generated by components of the printed circuit board 311 by being in direct contact with the printed circuit board 311 and the resonating unit 320.

That is, the heat dissipation plate 312 is in direct contact with the resonating unit 320, and accordingly, even when the heat dissipation plate 312 is further included in the heater assembly 300, a size of the heater assembly 300 may not increase significantly, and an excellent heat dissipation effect may be obtained as the heat dissipation plate 312 is in surface contact with the printed circuit board 311. The oscillating unit 310 may be soldered onto a surface of the resonating unit 320. For example, the heat dissipation plate 312 of the oscillating unit 310 may be soldered onto the surface of the resonating unit 320. Soldering bonds different metals to each other, and by heating and melting a solder and then cooling the solder, the different metal materials may be bonded and connected to each other. The solder may be melted and cooled between the resonating unit 320 and the heat dissipation plate 312, thereby bonding the resonating unit 320 to the heat dissipation plate 312.

The heat dissipation plate 312 may be a solderable metal material. In one embodiment, the heat dissipation plate 312 may be formed of an aluminum material with relatively excellent heat dissipation performance and processability compared to other metals. In addition, the heat dissipation plate 312 may have a structure in which a surface of the heat dissipation plate 312 is nickel-plated to enable soldering. In another example, the heat dissipation plate 312 may also be formed of copper.

The heat dissipation plate 312 may have a size and surface shape similar to a size and surface shape of the printed circuit board 311. However, the size and shape of the heat dissipation plate 312 may be modified in various ways.

In addition, the solder used for soldering may include at least one metal selected from a group including silver (Ag), lead (Pb), tin (Sn), bismuth (Bi), aluminum (Al), zinc (Zn), and indium (In), or an alloy of the metals. An alloy of metals having a relatively lower melting temperature than a single material solder may be used as the solder.

In one embodiment, a case 321 of the resonating unit 320 may be formed of a material that is easily soldered or may be surface-treated to facilitate soldering. For example, the surface treatment may mean that the case 321 of the resonating unit 320 is plated with a material including gold (Pt), silver (Ag), or tin (Sn), or a mixture of the metals. In addition, in order to facilitate a soldering process, a process of applying flux to a surface of the case 321 of the resonating unit 320 may be added. However, the material used for the surface treatment and a surface treatment method may be applied in various ways depending on purposes and are not limited thereto.

As described above, because the oscillating unit 310 is directly arranged on the resonating unit 320 of the heater assembly 300, a size of an aerosol generating device using a dielectric heating method may be reduced, and at the same time, the resonating unit 320 may effectively dissipate the heat generated by the oscillating unit 310 through the structure described above.

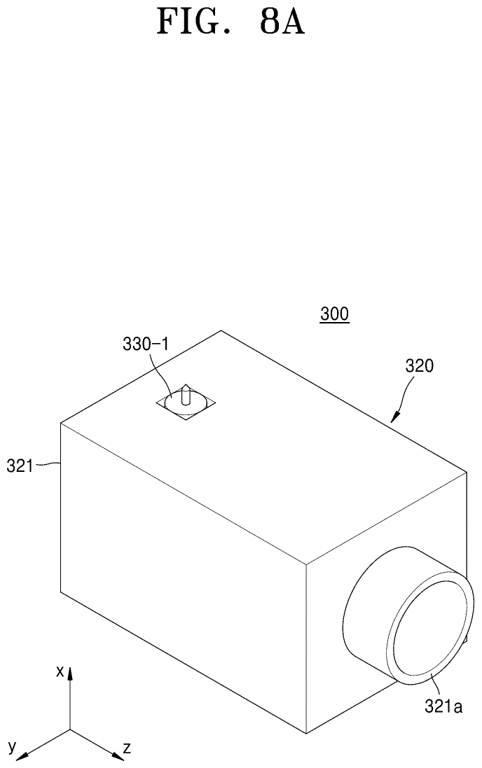

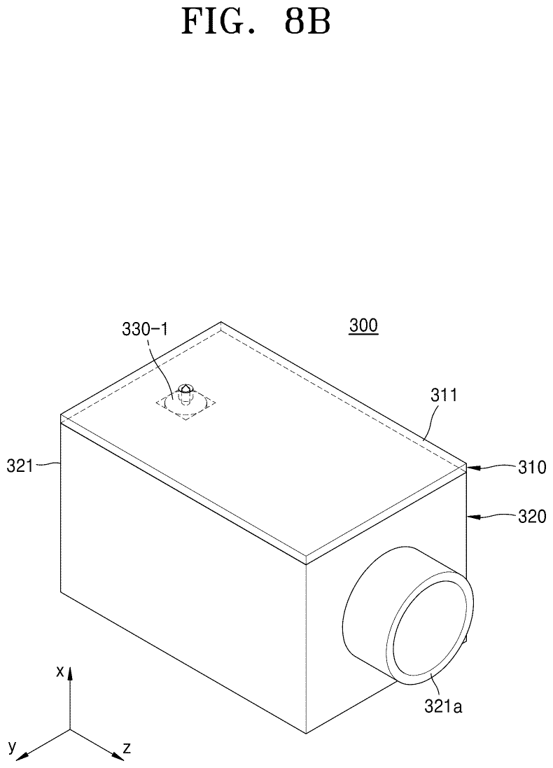

FIGS. 8A and 8B schematically illustrate methods of manufacturing the heater assembly of FIG. 7A.

FIG. 8A schematically illustrates a form in which the coupler 330-1 is attached to the resonating unit 320 of the heater assembly 300.

Referring to FIG. 8A, the coupler 330-1 may protrude (for example, in the +x direction of FIG. 8A) on one surface of the case 321 of the heater assembly 300. However, the arrangement position and shape of the coupler 330-1 is not limited to the illustration of FIG. 8A, as long as one end of the coupler 330-1 is in contact with the oscillating unit 310 and the other end thereof is in contact with the resonating unit 320.

Referring to FIG. 8B, the printed circuit board 311 may be stacked on one surface of the resonating unit 320 from which the coupler 330-1 protrudes in the heater assembly 300. The printed circuit board 311 may be in contact with the case 321 of the resonating unit 320. In addition, the printed circuit board 311 may include a hole through which the coupler 330-1 may protrude.

In one embodiment, the oscillating unit 310 may be stacked to cover at least a part of a surface of the resonating unit 320. In addition, as illustrated in FIG. 8B, the oscillating unit 310 may have the same length and width as a length and width of the surface of the resonating unit 320 to completely cover the surface of the resonating unit 320. In FIG. 8B, only an embodiment in which the oscillating unit 310 is stacked on one side of the resonating unit 320 facing the +x direction is illustrated, but the present disclosure is not limited to the illustrated embodiment.

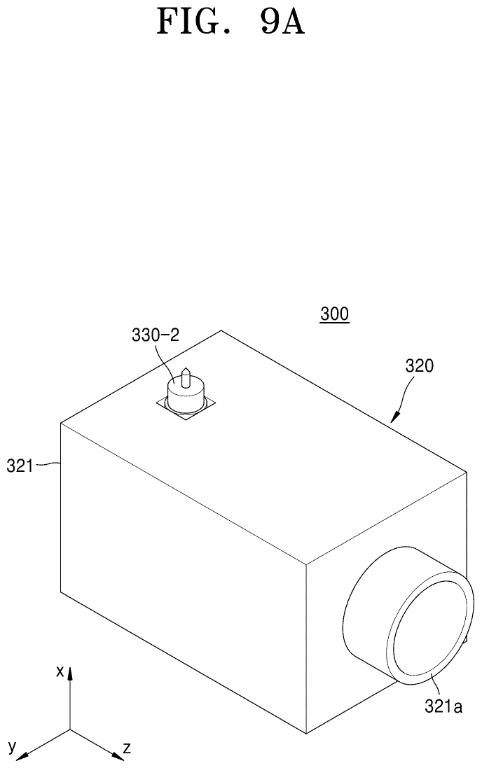

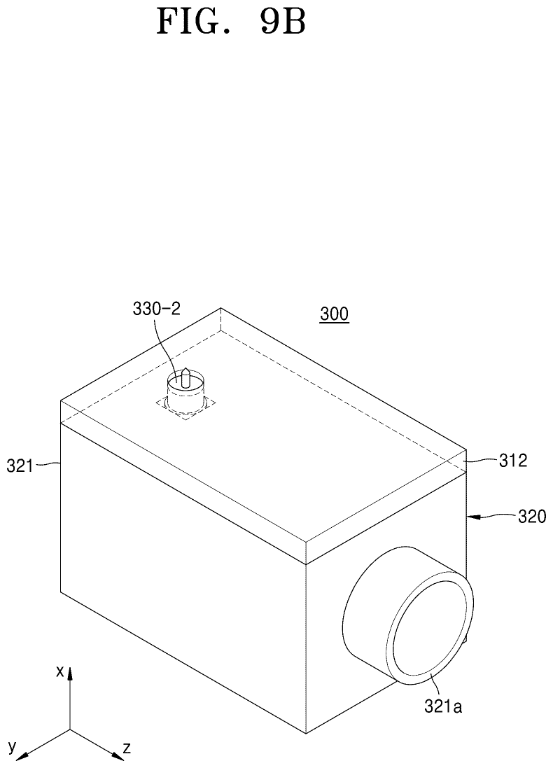

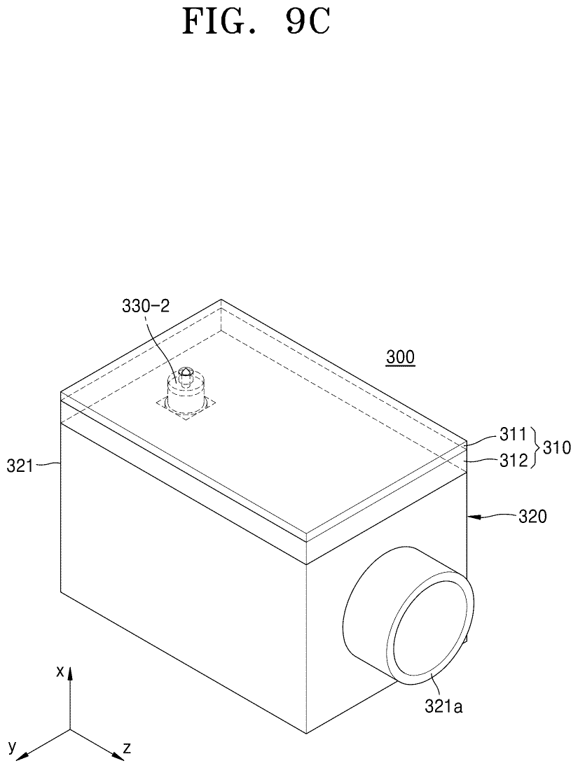

FIGS. 9A to 9C schematically illustrate methods of manufacturing the heater assembly of FIG. 7B.

FIG. 9A schematically illustrates a form in which the coupler 330-2 is attached to the resonating unit 320 of the heater assembly 300. In describing FIG. 9A, descriptions made above with reference to 8A are omitted.

Referring to FIG. 9B, the heat dissipation plate 312 may be stacked on one surface of the resonating unit 320 from which the coupler 330-2 protrudes in the heater assembly 300. The heat dissipation plate 312 may be in contact with the case 321 of the resonating unit 320. In addition, the heat dissipation plate 312 may include a hole through which the coupler 330-2 may protrude.

Referring to FIG. 9C, the printed circuit board 311 may be stacked on a surface of the heat dissipation plate 312. That is, the heat dissipation plate 312 may be stacked on a surface of the resonating unit 320, and the printed circuit board 311 may be sequentially stacked on the surface of the heat dissipation plate 312. The printed circuit board 311 may include a hole through which the coupler 330-2 may protrude.

In addition, unlike sequentially following the manufacturing method illustrated in FIGS. 9A to 9C, the oscillating unit 310 in which the heat dissipation plate 312 and the printed circuit board 311 are previously stacked may be stacked on the heater assembly 300 of FIG. 9A.

In one embodiment, the oscillating unit 310 may be stacked to cover at least a part of a surface of the resonating unit 320. In addition, as illustrated in FIG. 9C, the oscillating unit 310 may have the same length and width as a length and width of the surface of the resonating unit 320 to completely cover the surface of the resonating unit 320. Although FIG. 9C illustrates only an embodiment in which the oscillating unit 310 is stacked on one side of the resonating unit 320 facing the +x direction, the present disclosure is not limited to the illustrated embodiment.

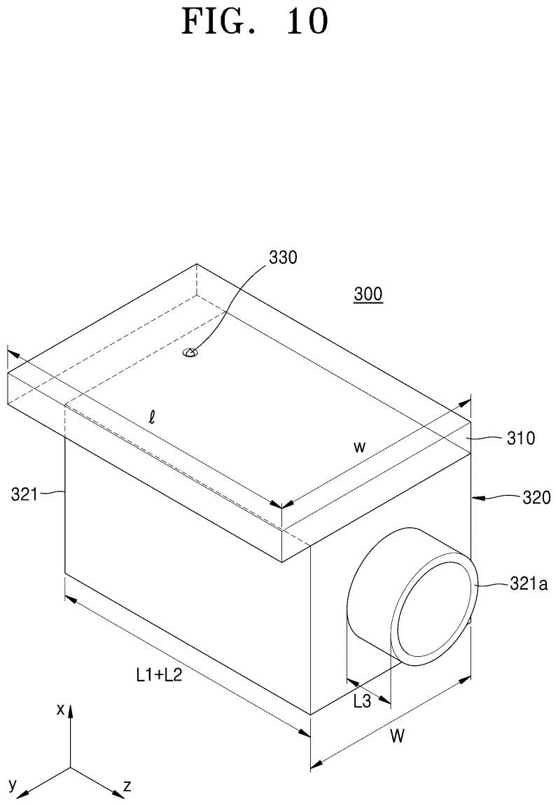

FIG. 10 is a perspective view of a heater assembly according to an embodiment.

Referring to FIG. 10, the oscillating unit 310 is stacked on a surface of one side facing the +x direction of the resonating unit 320, and the surface of the resonating unit 320 on which the oscillating unit 310 is stacked may have a width W and a length L1+L2. In addition, a length from a rear end where an opening 321a of the resonating unit 320 is connected to the case 321 to a front end of the opening 321a where the opening 321a is open may be L3.

In one embodiment, the oscillating unit 310 may have a width w greater than the width W of the surface of the resonating unit 320, and may be stacked to protrude in the y direction. Alternatively, the oscillating unit 310 may have a length I greater than the length L1+L2 of the surface of the resonating unit 320, and may be stacked to protrude in the z direction. The length L1+L2 of the surface of the resonating unit 320 described above may indicate the length L1+L2 of an internal space of the case 321 excluding the opening 321a of the case 321 of the resonating unit 320.

In addition, the oscillating unit 310 may have the width w and the length I greater than the width W and the length L1+L2 of the surface of the resonating unit 320, and may be stacked to protrude in the y direction and the z direction. Therefore, the printed circuit board 311 and so on of the oscillating unit 310 may include more diverse components.

FIG. 10 illustrates an embodiment in which the width w of the oscillating unit 310 is greater than the width W of the surface of the resonating unit 320 on which the oscillating unit 310 is stacked, and at the same time, the length I of the oscillating unit 310 is greater than the length L1+L2 of the surface of the resonating unit 320.

In one embodiment, when the length I of the oscillating unit 310 is greater than the length L1+L2 of the surface of the resonating unit 320, the oscillating unit 310 may extend in a direction (for example, the-z direction) opposite to a direction (for example, the +z direction) in which the opening 321a into which an aerosol generating article may be inserted is located. Accordingly, even when the entire length of the heater assembly 300 is not extended, a space for arranging the oscillating unit 310 may be obtained without affecting a position where a user inhales an aerosol generating article, and accordingly, a size of an aerosol generating device may be reduced.

That is, referring to FIG. 10, the size reduction of the aerosol generating device may be made in a case where the length I of the oscillating unit 310 is greater than the length L1+L2 of the surface of the resonating unit 320, based on a surface in the +x direction in which the oscillating unit 310 is stacked on the resonating unit 320. In FIG. 9, the opening 321a of the resonating unit 320 is located in the +z direction, and the oscillating unit 310 may extend in the −z direction.

That is, even when the length I of the oscillating unit 310 increases, when a user inhales an aerosol generating article inserted through the opening 321a of the resonating unit 320, the oscillating unit 310 may be arranged so as not to cause spatial inconvenience.

In another embodiment, even when the oscillating unit 310 extends in the +z direction, the oscillating unit 310 may be shorter than a length L3 from the rear end of the opening 321a to the front end of the opening 321a.

In one embodiment, the oscillating unit 310 may further include a cover (not illustrated) that protects the printed circuit board 311. The cover may include a heat dissipating material. As the oscillating unit 310 includes the cover, the oscillating unit 310 may effectively dissipate the heat generated by components of the printed circuit board 311.

For example, the resonating unit 320 may be located at the bottom of the printed circuit board 311, and the cover may be located at the top of the printed circuit board 311, that is, the resonating unit 320 and the cover may be located at respective layers with the printed circuit board 311 therebetween, and thus, even a miniaturized aerosol generating device may have an excellent heat dissipation effect.

In another embodiment, the cover protecting the printed circuit board 311 may be included in the housing 110 (see FIG. 1) rather than the heater assembly 300. That is, an aerosol generating device may include a housing including an insertion hole into which an aerosol generating article is inserted, and the heater assembly 300 for heating the aerosol generating article inserted through the insertion hole by using a dielectric heating method.

The printed circuit board 311 may be exposed because the heater assembly 300 does not include a separate cover, and the cover included in the housing may protect the printed circuit board 311 of the heater assembly 300 because the heater assembly 300 is in an internal space of the housing.

In addition, according to an embodiment, the method of manufacturing the heater assembly 300 described above may include providing the resonating unit 320, connecting one end of the coupler 330 to the resonating unit 320, and stacking the oscillating unit 310, which includes the printed circuit board 311 in contact with the other end of the coupler 330, on the resonating unit 320.

In addition, the above description made to describe components of the heater assembly 300 and an aerosol generating device including the heater assembly 300 may also be applied to a method of manufacturing the heater assembly 300.

In one embodiment, in the stacking of the printed circuit board 311 on the resonating unit 320, a solder may be provided on a surface of the resonating unit 320 to bond the resonating unit 320 to the oscillating unit 310.

Any embodiments of the present disclosure or other embodiments described above are not mutually exclusive or distinct from each other. Any embodiment or other embodiments described in this disclosure may be combined with one another, both in terms of configurations and functions.

For example, configuration A from a specific embodiment and/or drawing can be combined with configuration B from another embodiment and/or drawing. This means that even if a combination of components is not explicitly described, such combinations are still possible unless specifically stated otherwise.

The detailed description above should not be interpreted as limiting in any respect, but rather as illustrative. The scope of the present invention should be defined by a reasonable interpretation of the appended claims, and all modifications that fall within the equivalent scope of the present invention are included in its scope.

1. A heater assembly for heating an aerosol generating article through a dielectric heating method, the heater assembly comprising:
an oscillating unit configured to generate microwaves;
a resonating unit configured to generate an electric field by resonating the microwaves; and
a coupler having one end in contact with the oscillating unit and another end in contact with the resonating unit and configured to transmit the microwaves generated by the oscillating unit to the resonating unit,
wherein the oscillating unit includes a printed circuit board stacked on the resonating unit.

2. The heater assembly of claim 1, wherein the printed circuit board is soldered to a surface of the resonating unit.

3. The heater assembly of claim 2, wherein the resonating unit further includes a plating layer covering the surface of the resonating unit.

4. The heater assembly of claim 2, further comprising a solder located between the resonating unit and the printed circuit board to bond the resonating unit to the printed circuit board.

5. The heater assembly of claim 4, wherein the solder includes at least one metal selected from a group consisting of silver (Ag), lead (Pb), tin (Sn), bismuth (Bi), aluminum (Al), zinc (Zn), and indium (In), or an alloy thereof.

6. The heater assembly of claim 1, wherein
the resonating unit has an opening, on one side, into which the aerosol generating article is insertable,
a length of the oscillating unit is greater than a length of the resonating unit, and
the oscillating unit extends in a direction opposite to a direction in which the opening is located.

7. The heater assembly of claim 1, wherein the printed circuit board has a hole through which the coupler passes.

8. The heater assembly of claim 7, wherein the coupler is exposed on a surface of the printed circuit board.

9. The heater assembly of claim 1, wherein the heater assembly further includes a cover configured to protect the printed circuit board.

10. An aerosol generating device comprising:
a housing having an insertion hole into which an aerosol generating article is inserted; and
a heater assembly for heating the aerosol generating article inserted through the insertion hole,
wherein the heater assembly includes an oscillating unit including a printed circuit configured to generate microwaves, a resonating unit configured to generate an electric field by resonating the microwaves, and a coupler having one end in contact with the oscillating unit and another end in contact with the resonating unit and configured to transmit the microwaves generated by the oscillating unit to the resonating unit, and the oscillating unit is stacked on the resonating unit.

11. The aerosol generating device of claim 10, wherein the housing further includes a cover that protects the printed circuit board.

12. A method of manufacturing a heater assembly for heating an aerosol generating article, the method comprising:
providing a resonating unit;
connecting a coupler to the resonating unit such that one end of the coupler is in contact with the resonating unit; and
stacking an oscillating unit on the resonating unit, the oscillating unit comprising a printed circuit board stacked on the resonating unit and being in contact with another end of the coupler.

13. The method of claim 12, wherein, in the stacking of the oscillating unit, a solder is provided onto a surface of the resonating unit to bond the resonating unit to the oscillating unit.
